(19) United States
(12) Patent Application Publication
(10) Pub. No.: US 2012/0258741 A1
(43) Pub. Date: Oct. 11, 2012

(54) Apparatus and Method for Using a Wireless Mobile Handset Application to Locate Beacons

(75) Inventors: John McFarlin Tillson, San Diego, CA (US); James Ladd Berntsen, Ramona, CA (US); Bruce Kennard, San Diego, CA (US)

(73) Assignee: COMPASS AUTO TRACKER, LLC., Poway, CA (US)

(21) Appl. No.: 13/441,720

(22) Filed: Apr. 6, 2012

Related U.S. Application Data
(60) Provisional application No. 61/472,775, filed on Apr. 7, 2011.

(51) Int. Cl. H04W 24/00

(52) U.S. Cl. 455/457

(57) ABSTRACT

An apparatus and method for adding functionality to wireless mobile handsets, mobile phones, smart phones and other portable wireless devices which allows the devices to report the direction and distance of a wireless beacon that is attached to objects in need of being tracked or found. An external protective case is coupled to an existing mobile handset which comprises a plurality of directional antennas and associated RF circuitry. The electronics of the case are coupled to the electronics of the handset and with assistance of downloaded software of an associated application program, the handset may used to track or find one more beacons that have been previously paired with it.

### RELATED APPLICATIONS

The present application is related to U.S. Provisional Patent Application Ser. No. 61/472,775, filed on Apr. 7, 2011, which is incorporated herein by reference and to which priority is claimed pursuant to 35 USC 119.

### BACKGROUND

1. Field of the Technology

The disclosure relates to the field of accessories for wireless devices, specifically an apparatus and methods for adding functionality to wireless mobile handsets, mobile phones, smart phones and other portable wireless devices that allows the devices to report the direction and distance of wireless beacons that are attached to a plurality of objects in need of being tracked and found.

2. Description of the Prior Art

Mobile handsets and other mobile wireless devices are quickly converging and becoming the single device that performs a multitude of tasks that consumers desire. These devices typically have features such as a GPS (Global Positioning System) receiver, magnetic compass, wireless data network access to the internet, a wireless transceiver for linking with hands-free microphones or headsets, color graphics display, and one or multiple CPUs (Central Processing Units) for controlling all of the functions of the device. Application programs (“apps”) are available for many of these devices for the purpose of locating and keeping track of objects or people and using the GPS system and internet access to download map information for displaying the location of the object. However, these solutions have several significant limitations and drawbacks. For example, the user must remember to pre-set a “way-point” location that they want to return to sometime in the future, the accuracy of the location information can be diminished indoors and many other circumstances by the lack of clear access to GPS satellite signals, the accuracy of the directional information typically provided by GPS systems is poor when in relatively close proximity (under 100 feet/30 meters) to the destination, and the mobile handset cannot indicate the direction of a beacon attached to the object. Other wireless devices exist that are not mobile handsets but are designed to track and locate various objects, but these devices suffer from many of these same limitations and drawbacks.

### BRIEF SUMMARY

This new functionality is added to an existing mobile handset through an external protective casing that contains directional antennas and associated radio frequency “RF” circuitry, and by downloading and running an associated application program (“app”).

It is one objective of the present invention to allow consumers to add to their smartphone or other wireless handset the functionality of indicating the direction and distance from the handset to a small wireless beacon that has been previously placed on an object or person that the user wishes to locate anywhere inside, outside, or across the nation. By making the process of adding this function to the handset as simple as installing a protective casing and downloading a direction finder app (“Finder App”), the attraction for consumers is extremely strong.

The functionality contained in the embodiment of the direction Finder App for mobile handsets utilizes a directional antenna array and an associated proprietary direction detecting algorithm, combined with software created for the app that employs novel techniques for locating devices that are paired to the handsets through their Wireless Personal Area Network controller.

The directional finder antenna array comprises two antennas, an omni-directional antenna and a directional antenna. Alternatively, the array comprises a plurality of antennas with differing radiation patterns and a circuit and methodology for determining the direction of the beacon by comparing the field strengths of the signal received from the remote object by the antennas as the handset is moved throughout a plurality of possible directions of the beacon. This technique is known as “Radio Direction Finding” (RDF). When combined with a digital compass, a sweep of the field of observation generates signal comparison data points corresponding to each direction in which the directional antenna is pointed. The direction finder stores field strength data by compass heading according to a pre-determined algorithm and indicates the most likely direction of the transmitting beacon.

The transmitting beacon is typically a transceiver that is attached to an object in need of being found. Examples of these objects are children, pets, cars, luggage, keys, bicycles, friends, phones, or just about anything people might want to find. The beacon is typically powered by rechargeable or non-rechargeable batteries and is packaged appropriately for the specific application. It typically has a single antenna and embedded software to establish a node-to-node Wireless Personal Area Network (WPAN) with the direction finder utilizing a digital channel access methodology such as that found in Bluetooth® devices. In an alternative embodiment, the beacon includes an additional GPS receiver and wireless network access hardware and software that extends the range of the direction finding system to anywhere in the world where wireless network signals are available.

Typically the beacon remains in a low-power “sleep mode” state and wakes up periodically to determine if the direction finder is attempting to contact it. If no attempt is being made, the beacon returns to the sleep mode. If the direction finder is attempting to contact the beacon, then the beacon first confirms the direction finder unique I.D. with those to which it has been previously paired and responds by acknowledging the direction finder. The beacon then enters “finding mode” by maintaining constant contact with the direction finder. If and when the direction finder ceases to maintain contact with the beacon, the beacon will remain in transmit mode for another period of time for the circumstance where the direction finder wishes to re-initiate finding mode so that latency is reduced.

Alternatively in safety and rescue applications the beacon can be automatically turned on if for instance exposed to water, an accelerometer detects a sufficient motion, or if a button is pressed due to an immediate emergency.

For the cases where the beacon also contains the GPS and wireless data network access functions, the device can be programmed to report its GPS coordinates to a pre-determined website at a set interval, or can be in a low-power state that only reports its GPS coordinates upon request from the website or a paired handset.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a block diagram of the elements of the handset and the beacon of the current invention.

FIG. 2 is a frontal view of wireless mobile handset with a graphical display of “App buttons”, one of which is the Finder App button.

FIG. 3 is a frontal view of the wireless mobile handset seen in FIG. 2 after the Finder App has been selected to start execution and the functional choices displayed are “Pair a New Beacon” and “Find a Beacon”.

FIG. 4 is a frontal view of the wireless mobile handset seen in FIG. 3 after the functional choice “Pair a New Beacon” has been selected to start execution and the WPAN network controller enters the pairing mode where it detects other compatible wireless devices in the area.

FIG. 5 is a frontal view of the wireless mobile handset seen in FIG. 3 after the functional choice “Find a Beacon” has been selected to start execution as displayed by the message and all beacons that have previously been paired to the handset are shown to select from.

FIG. 6 is a frontal view of the wireless mobile handset seen in FIG. 5 after the “Pet” beacon has been selected to be searched for and the app has successfully located the beacon using the wireless network access controller.

FIG. 7 is a frontal view of the wireless mobile handset seen in FIG. 6 after the “Pet” beacon is within the range of the WPAN network and has used RDF mode to locate the beacon.

FIG. 8 is a block diagram of a case for a wireless mobile handset that comprises a directional antenna array embedded into the material of the casing, along with the hardware and software necessary to connect and communicate to the handset.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

The preferred embodiment of the direction finder in a mobile wireless handset utilizes hardware features that currently exist in most handsets, primarily the data network access to the internet, GPS receiver, digital compass, screen display, and CPU(s) for executing software code. An external protective casing around the phone that contains an embedded WPAN (i.e. Bluetooth) transceiver, an array of directional antennas, a switch to select between directional antennas, a controller, and a connector to the phone serial port is provided. The preferred embodiment also comprises the instance where more than two antennas are used. This array of antennas and switch constitutes the antennas necessary for the RDF portion of the direction finder functionality.

The downloadable Finder App is made available through the wireless mobile service providers who traditionally offer apps to their customers. Once downloaded to the mobile device, the Finder App has a user interface that allows for pairing of a plurality of specific beacons to be tracked and located in the future. The actual pairing process is conducted like any other WPAN device pairing process where the handset device and the beacon device exchange a unique passkey or I.D. number. Once paired, the user has the option of naming the pairing, i.e. “Jeffy” for a child's beacon, “Spot” for a pet's beacon, etc. The user can then install the beacon on the child, pet, or other object they desire to keep track of.

In FIG. 1, the various components of the handset 116 and a beacon 140 are shown in block diagram form. The hardware of the handset 116 comprises a wireless data network controller and antenna 101 which is coupled to a controller or processor 102. The controller 102 comprises sufficient processing ability and memory capacity to download and run the Finder App 120 through the wireless data network controller 101. A graphics controller and display 103 is coupled to the controller 102 and is capable of sufficient resolution and size for displaying maps and other graphical images on the touch-screen display of the handset 116. A global positioning system receiver and antenna or other position sensing system 104 is also coupled to the controller 102 along with a WPAN (Wireless Personal Area Network) transceiver 105. The WPAN transceiver 105 comprises an RF transmit power mode sufficient to reach distances over which the handset 116 can communicate with one or more paired beacons 140. In other embodiments, the WPAN transceiver 105 comprises additional power modes to reach 100 meters or more. An RSSI (Receive Signal Strength Indicator) meter 106 coupled to the WPAN transceiver 105 and controller 102 is used for measuring the received signal strength from the WPAN transceiver 105. In one embodiment, the RSSI meter 106 is a built-in component of the WPAN transceiver 105. The handset 116 further comprises a digital compass 109 coupled to the controller 102 and GPS system 104. In a further embodiment, the handset 116 comprises an accelerometer.

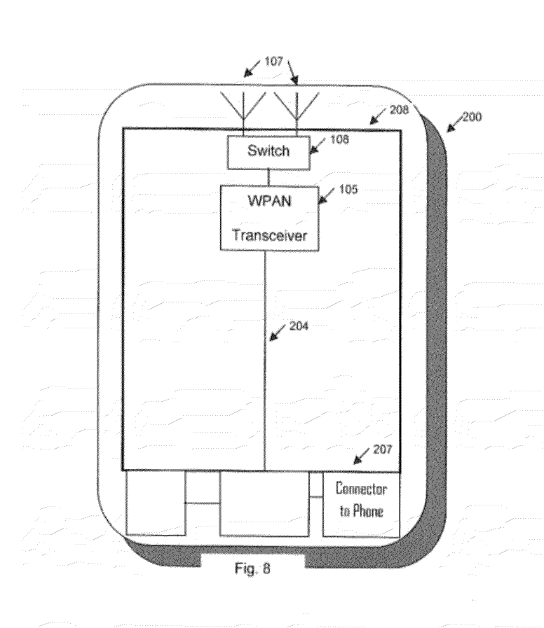

The internal components of the handset 116 are augmented by the case 200 (seen in FIG. 8) which comprises a pair of WPAN antennas 107 coupled to the WPAN transceiver 105 of the handset 116 via a switch 108 that is controlled by the controller 102. The WPAN antennas 107 comprise an omni-directional antenna and a directional antenna which are tuned according to the specific handset 116 hardware implementation and separated by a parasitic element as known in the art. The WPAN antennas 107 are added to the handset 116 via the case 200 to improve the direction finding ability of the handset 116 and facilitate its use as a direction finder. As seen in FIG. 8, the case 200 comprises a cutout 208 for the handset 116, allowing the display 117 of the handset 116 to be seen through the cutout 208. The case 200 comprises an embedded directional antenna array 107, switch 108, and WPAN transceiver 105 disposed in the rear of the case 200 opposing the cutout 208. The components of the case 200 link to the controller 102 and the RSSI Receive Signal Strength Indicator 106 of the handset 116 via a connector to the phone 207 located near the data port of the handset 116.

As also seen in FIG. 1, the components of a beacon 140 may be seen. Each beacon 140 comprises a WPAN transceiver 110 with RF transmit power modes sufficient to reach distances over which the beacon can communicate with paired handsets. In one particular embodiment, such power modes reach 100 meters or more. A RSSI (Received Signal Strength Indicator) meter 112 is coupled to the WPAN transceiver 110 and is used for measuring its received signal strength. In one embodiment, the RSSI meter 112 is a built-in component of the WPAN transceiver 110. The WPAN transceiver 110 also has a WPAN antenna 112 directly coupled to it. Both the RSSI meter 112 and WPAN transceiver 110 are coupled to beacon controller 113 with programming instructions stored on its internal memory to pair and communicate with other devices over a WPAN network. Each beacon 140 also comprises a global positioning module 114 other position sensing system with its own antenna. A wireless data network controller and antenna 115 is coupled to the GPS module 114 and beacon controller 113. The GPS module 114 and network controller 114 allow the beacon 140 to determine its location using the GPS receiver portion of the GPS module 114 and to report its location when outside of the range of the WPAN.

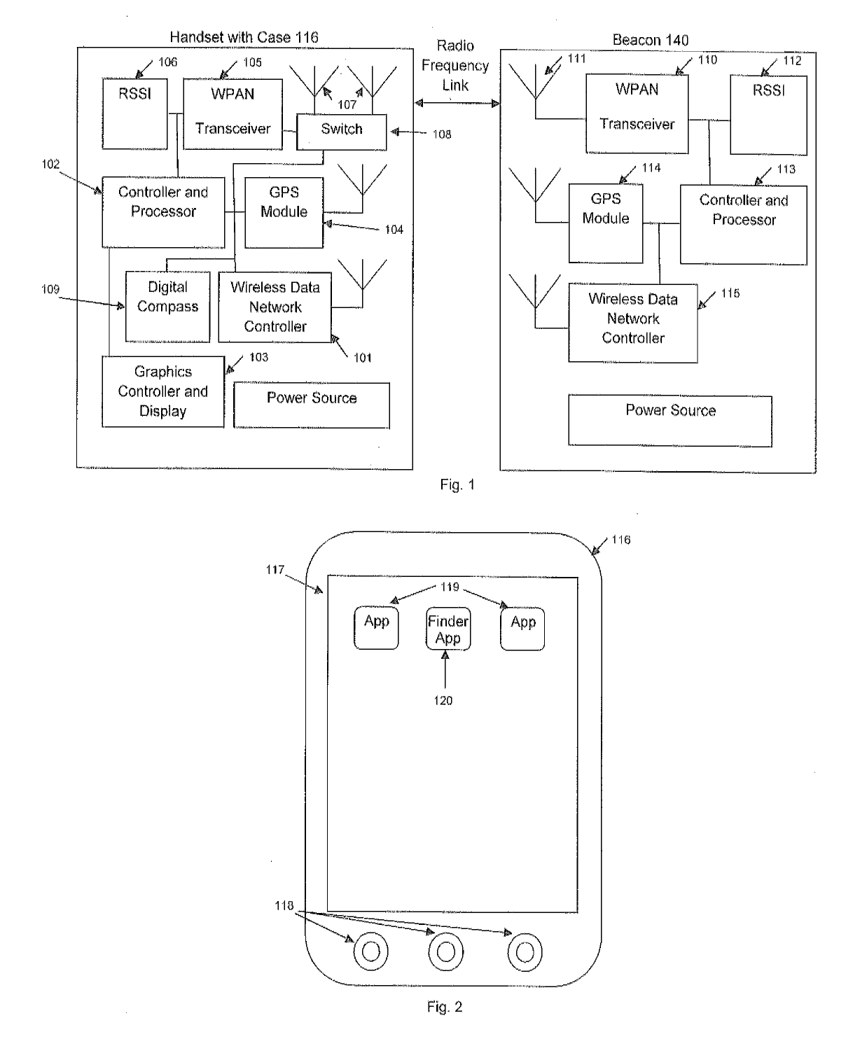

When a user wants to locate an object, the user accesses the Finder App 120 that has been previously downloaded onto their handset 116 from a plurality of other apps 119 located on the screen 117 of their handset 116 as seen in FIG. 2. The user selects the Finder App 120 by either using the touch screen functionality of the handset 116, by manipulating a plurality of user controls 118.

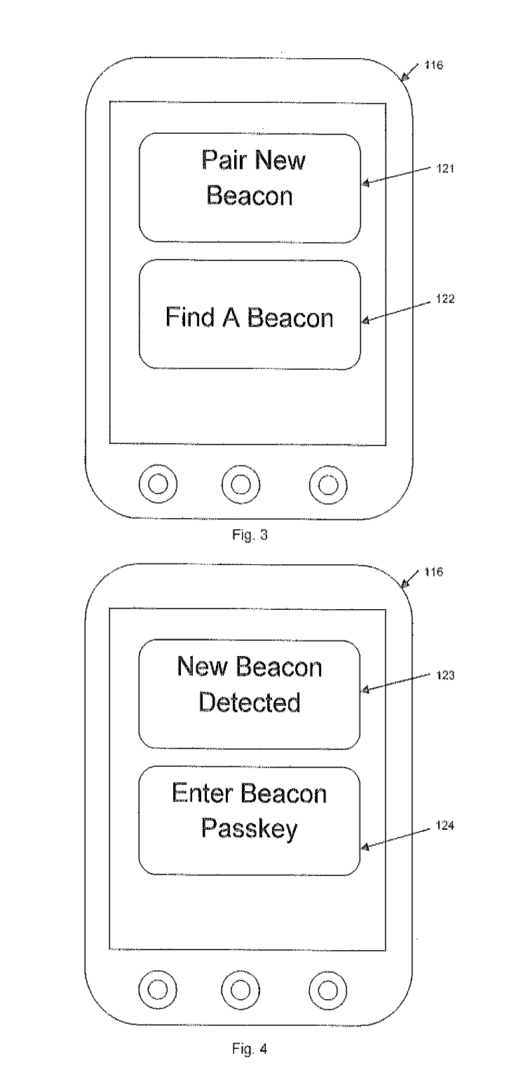

Once the Finder App 120 is selected, the handset 116 displays the next available options to the user, specifically to “Pair a New Beacon” 121 or to “Find a Beacon” 122 as seen in FIG. 3. If a new beacon 140 is to be paired with the handset 116, the handset 116 may indicate that a new beacon 140 has been detected 123 and give the user the opportunity to enter a beacon passkey 124 to complete the pairing process as seen in FIG. 4. The user then selects the option to locate one of the beacons the handset 116 has previously paired with, that is the “Find A Beacon” 122. The handset 116 then displays a plurality of beacons which are available to the user to locate as seen in FIG. 5, each with their own corresponding icons 126 and labels 127, 128, and 129 for the user to differentiate and aid in selecting a particular beacon to locate.

Once the desired beacon is selected, the handset 116 displays the first of a sequence of status screens to inform the user of the status of the search. In the first phase of the search mode, the handset 116 displays a message indicating that it is searching for the beacon 140 and executes an algorithm that attempts to communicate with the beacon 140. The first step of this initial communication algorithm is to attempt to contact the beacon 140 through the short-range WPAN channel. If the handset 116 can successfully communicate with the beacon 140, then it displays a message on the screen 117 for the user that the beacon 140 has been contacted and requests the user to scan the area. To scan the area the user presses a “Scan Area” button on the handset touch screen display 117 and sweeps the handset 116 throughout the field of observation while continuing to press the Scan Area button. When the user has completed the sweep, the button is released indicating to the Finder App that the sweep has finished.

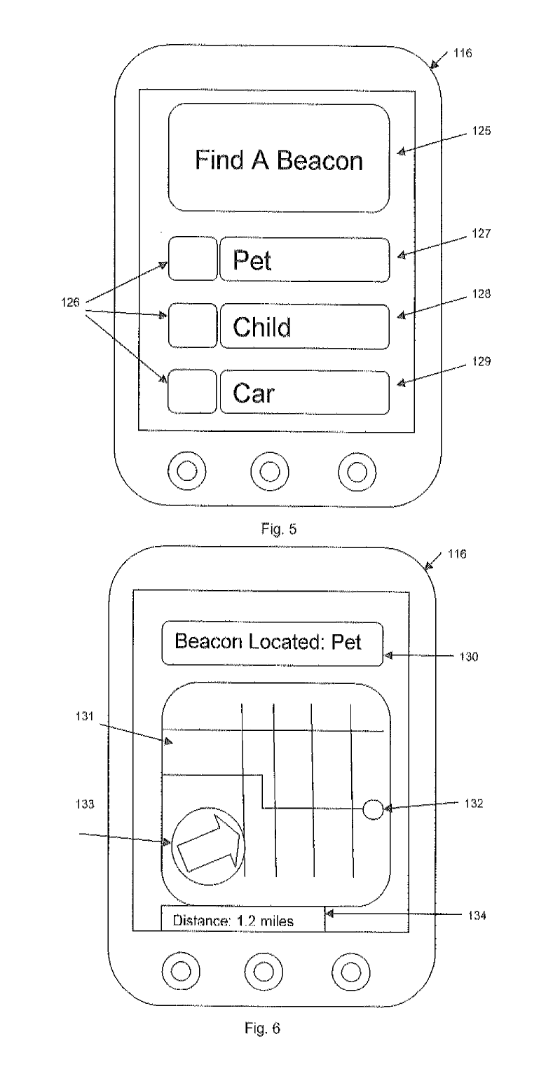

While the “Scan Area” button is pressed, the Finder App uses the directional antennas 107 to determine the relative signal strength and stores field strength data by compass heading according to a pre-determined algorithm. The Finder App displays the direction of the beacon 140 with an arrow fixed to the most likely direction of the transmitting beacon 140 and indicates the distance in the appropriate units (feet/meters, miles/kilometers) as seen in FIG. 6.

If the handset 116 is successful, a display as seen in FIG. 6 is used to indicate that the process to locate the specified beacon 140, for example, a pet beacon 130, has been successful 130. A map 131 is displayed where the beacon 140 has been located 132 using the GPS mode because the beacon 140 is outside of the RDF range. Also indicated on the map 131 is the direction 133 and distance 134 from the handset 116 to the beacon location 132.

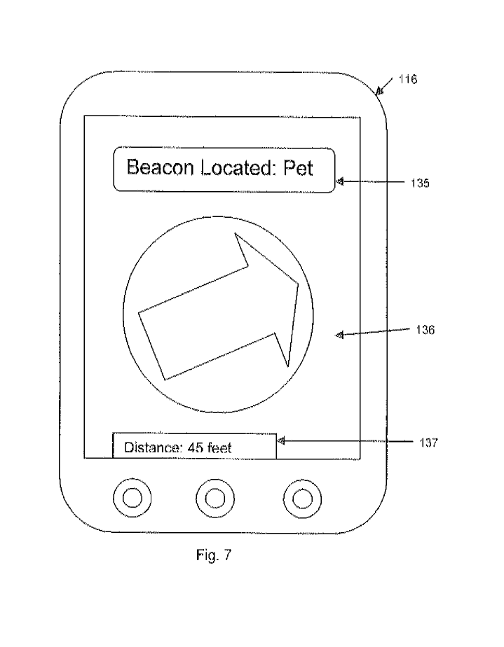

FIG. 7 is a representation of the handset 116 display when the desired beacon 140 has been successfully located in the “RDF” mode 135. The handset 116 indicates on the display screen 117 the direction of the beacon 140 with a directional arrow 136 and a distance indicator 137 which displays the distance from the handset 116 to the beacon 140.

If the handset 116 is unable to contact the beacon 140 through the short-range WPAN channel, it then attempts to locate the beacon 140 through a wireless data network access algorithm. In one embodiment, this algorithm is for the handset 116 to contact a website that tracks and logs the location of beacons 140 which have been previously paired to the handset 116 and registered on the website by the user. The handset 116 requests the GPS coordinate location of the desired beacon 140 from the website and this data is immediately reported back to the handset 116. If the coordinate information is not available, the website contacts the beacon 140 through the wireless data network and requests the location information. During this process, the Finder App 120 displays the status to the user on the screen 117 of each step that is taking place, such as “contacting beacon through wireless network”, and “waiting for location information from beacon”. When this coordinate information is reported to the website it is transmitted to the handset 116. If appropriate, the handset 116 will display the GPS coordinates on a map along with a compass direction arrow and distance indication, otherwise if the distance is short then only a compass direction arrow with distance indication is displayed.

Typically WPAN devices that pair with handsets 116 are hands-free microphones, headsets or other such devices. It should be noted that any known WPAN enabled device can be paired to the handset 116 and can thus become a beacon 140. The user may opt to utilize the short-range RDF functionality in the handset 116 to locate any paired WPAN device, as long as they are within the transmit range of that device. The user selects the Finder App 120 and then selects the paired WPAN device from the paired devices menu, and the user could then locate the device using the algorithm as described above.

In another embodiment, this feature can be extended to other handsets 116 that have the Finder App 120 installed and have been properly paired to each other. In this way a handset 116 can be used to locate a second misplaced or missing handset 116, as long as the WPAN function is enabled in the handset 116 that is being located. Because these handsets 116 typically contain GPS functions, this feature can help locate a missing handset 116 anywhere in the world where wireless data network signals are available. To accomplish this both handsets 116 must be within WPAN range of each other, they both must be running the Finder App 120, and both must be authorized by their users to pair with the other respective handset 116. Once this pairing has been completed, one handset 116 can then be used to locate the other.

To do so, the user of the first handset selects the second handset as the device to locate, then attempts to communicate with the second handset through the WPAN network. When the second handset establishes communication with the first, it becomes a beacon and the first handset uses RDF techniques to locate the second.

In the case where the second handset is located outside of the WPAN network range, the first handset attempts to locate the second handset through the wireless data network access algorithm as previously described and displays the GPS coordinates on a map along with a compass direction arrow and distance indication.

Additionally, the current embodiment can be used to demonstrate the usefulness of the full-function beacons for marketing purposes. When the Finder App 120 is first downloaded and installed, the Finder App 120 can enter a demo mode and request the user to pair it to an existing WPAN device such as a hands-free microphone or another handset device that has the Finder App 120 installed. Then the user could attempt to locate the paired device and experience the full feature set of the beacons. The user could then order beacons for their child, pet, keys, luggage or other object.

Common implementations of known Wireless Personal Area Network transceivers (i.e. Bluetooth) include an array of selectable transmit power options to accommodate devices that require extremely low power consumption or that operate over shorter or longer distances. The Finder App 120 can adapt the transmit power settings during the RF search mode operation to a higher power class so as to extend the distance over which to locate and communicate with beacons 140, or to a lower power class in shorter distance situations to reduce the impact of Radio Frequency (RF) signal reflections from large surfaces and objects.

RF signals in the high frequency range typically used in WPAN transceivers will reflect off of surfaces and objects around the transmitter which can impact the accuracy of the RDF directional determination. The effect of these reflections is to appear that the location of the beacon 140 is in multiple directions or an incorrect direction relative to the handset. Stronger RF signals are more likely to result in reflections than weaker RF signals. In common use, the Finder App 120 allows users to search for objects inside of buildings and at relatively close distances and a transmit power signal that is too strong will worsen the impact of reflections. To improve the sensitivity and accuracy of the Finder App 120, the algorithm determines if the signal strength is above a pre-determined threshold where the transmit power of the beacon 140 and the handset 116 can be reduced. The handset 116 initiates this determination at a point in time when the RSSI 106 within the WPAN transceiver 105 is above a predetermined threshold and then attempts to maintain communications with the beacon 140 at a lower transmit power level. The beacon 140 responds in kind to the reduced transmit power instruction from the handset 116 and adjusts its transmit power accordingly. If each transceiver 105, 110 maintains communication with the other, then the new transmit power settings are retained. If communication is not adequately maintained, the transmit power is adjusted to its original higher setting.

In another embodiment, the handset 116 may determine the location of a beacon 140 which is at a different elevation than the handset 116 itself. GPS typical elevation errors of 500 to 700 feet are much too large where errors ideally should not exceed ten feet. As the user approaches the vicinity of the beacon 140 and the Finder App 120 switches to the RDF mode, the altitude information of the object becomes more pertinent to the search activity. The user is prompted to select a mode that allows for the determination if the beacon 140 is located above or below the plane of the handset 116. In this embodiment, the handset screen 117 (while in the RDF mode) displays a button indicating that the user has the option of determining if the beacon 140 resides above or below his plane of reference. If the user selects this option then the handset 116 instructs the user to point above the user's head and to press a button that records the RDF signal strength, and then instructs the user to point down and press a button that again records the RDF signal strength. The handset 116 then uses the relative signal strength of each reading to determine and display if the beacon 140 being located above the user or below the user.

In another embodiment, the direction in which the beacon 140 is located may be continuously determined once an initial determination has been made. In GPS mode, the direction of the beacon 140 relative to true north is made by using satellite data but requires handset motion to make this determination. In some handsets which contain accelerometers and magnetometers, handset motion is not required to determine the direction of north. Once the direction of the beacon 140 relative to the handset compass information has been made as discussed above, the handset 116 locks that location relative to compass direction and continually points in the direction of the beacon 140 as the handset 116 is moved. After a pre-determined distance has been covered by the handset 116 the algorithm re-calculates the direction of the beacon relative to compass data and updates the arrow direction on the display.

When the handset converts to RDF mode, the user presses a “Scan Area” button on the handset touch screen display 117 and sweeps the handset 116 throughout the field of observation while continuing to press the Scan Area button. Once the Scan Area button is released the Finder App 120 displays the beacon direction arrow fixed to the most likely direction of the transmitting beacon 140 and indicates the distance in the appropriate units (feet/meters, miles/kilometers). The beacon direction is updated based on an algorithm that uses GPS satellite signals, magnetometers and/or accelerometers depending on the handset hardware platform. After a pre-determined distance has been covered by the handset 116 the display 117 can request the user to press the Scan Area button again to update the algorithm on the beacon direction and distance. In an alternative embodiment, the beacon location is approximated as the handset 116 is moved based on positional information generated by accelerometers, GPS information or other positioning systems in the handset 116.

In a separate embodiment, a safe zone or a “Geo-Fence” area can be established for the beacon 140 such that if the beacon 140 moves outside of a predetermined geographic area, the paired handset(s) 116 is (are) notified. The handset 116 displays a map of the last reported GPS location coordinates and the user can utilize the GPS mode and RDF mode for tracking and locating the beacon that has breached the “Geo-Fence.”

To improve the performance of the handset 116 in real-world applications, the algorithm determining the direction of the beacon 140 must be able to effectively accommodate situations where reflections of the original signal are received by the handset 116. By employing analog filters and/or Digital Signal Processing (DSP) techniques that are well known, the algorithm can differentiate and filter reflected signal paths from direct signal paths very efficiently and adjust the direction indication accordingly. There are a plethora of methods in common use to reduce or eliminate the effects of multipath. Ideally the handset platform contains the filters implemented in the original hardware, otherwise the filtering can be implemented in the software Finder App 120 itself.

In a related embodiment, under certain circumstances the user of the handset 116 may wish to protect their handset 116 from being paired with a beacon 140 without their consent. In this case, the user selects the option of executing a pre-determined algorithm specifically prohibiting the handset 116 from being paired with.

Under intended use circumstances the beacon 140 is coupled to a remote object that the user wishes to locate at any given time. The power source of the beacon 140, whether a rechargeable or non-rechargeable battery, is designed to notify the handset 116 when the battery voltage is sufficiently depleted such that the battery needs to be recharged or replaced. Once the handset 116 has successfully established communication with the beacon 140 and data packets are exchanged between the beacon 140 and the handset 116, the battery voltage status is contained as information in the packets from the beacon 140. If the battery voltage is below a pre-determined level, the handset 116 indicates such status on the user display 117 to warn the user that the beacon battery voltage is low. The preferred embodiment is for the beacon 140 to continue to operate until the battery is exhausted even while the voltage is below the low-voltage threshold. The low-voltage threshold is such that ample battery life remains for the notification to be reported prior to complete exhaustion. In an additional embodiment, the beacon 140 emits an audible indication that the battery voltage is below the low-voltage threshold.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. An apparatus for providing a determination of direction between a beacon and a wireless mobile handset comprising:
a removable external case comprising means for accommodating the wireless mobile handset,
a first plurality of antennas disposed in the case;
a second plurality of antennas disposed in the beacon;
a circuit coupled to the first plurality of antennas and disposed in the case to determine the signal strength of a location signal received at the first plurality of antennas transmitted from the second plurality of antennas and to determine by comparison of the received location signal at the first plurality of antennas a probable relative direction between the beacon and the wireless mobile handset; and
a software application stored within an internal memory of a controller disposed within the wireless mobile handset that comprises means for displaying on a display screen of the wireless mobile handset the signal strength and the probable relative direction between the beacon and wireless mobile handset as determined by the circuit.

2. The apparatus of claim 1 where the circuit further comprises:
a wireless personal area network (WPAN) transceiver disposed within the case and coupled to the first plurality of antennas through a switch;
a receive signal strength indicator (RSSI) coupled to the WPAN transceiver disposed within the case; and
means for coupling the WPAN transceiver disposed in the case to the controller within the wireless mobile handset.

3. The apparatus of claim 1 where the first plurality of antennas disposed in the case comprises at least one omni-directional antenna and at least one directional antenna.

4. The apparatus of claim 1 where the circuit disposed within the case comprises means for utilizing a wireless personal area network (WPAN) transceiver disposed within the wireless mobile handset to determine the signal strength of a location signal and a probable relative direction between the beacon and the wireless mobile handset.

5. The apparatus of claim 2 where the controller disposed in the wireless mobile handset is coupled to the WPAN transceiver and the switch disposed in the case through a link, the controller further comprising means for providing an operating platform for the software application stored within the internal memory of the controller.

6. The apparatus of claim 1 where the beacon further comprises:
a beacon controller;
a WPAN transceiver coupled to the beacon controller;
a RSSI coupled to the WPAN transceiver and the beacon controller;
a global positioning system (GPS) module coupled to the controller; and
a wireless data network controller coupled to the beacon controller.

7. The apparatus of claim 1 where the beacon comprises means for removably coupling to an object.

8. The apparatus of claim 6 where the WPAN transceiver of the beacon comprises means for pairing with a WPAN transceiver disposed in the case.

9. The apparatus of claim 3 where the software application comprises means for comparing the received signal strength received from the omni-directional antenna to the signal strength received from the directional antenna to generate relative directional information between the wireless mobile handset and the beacon.

10. A method for providing a determination of direction between a beacon and a wireless mobile handset comprising:
removably coupling a WPAN transceiver and SSSI disposed within a case to the wireless mobile handset;
selecting a beacon from a plurality of beacons displayed on the wireless mobile handset through a menu provided by a software application stored on an internal memory device within the wireless mobile handset;
scanning for the location of the selected beacon through a short-range WPAN channel with a plurality of antennas disposed within the case;
scanning for the location of the selected beacon through a wireless data network;
analyzing the location signals received from the selected beacon via an algorithm contained within the software application stored on a memory device within the wireless mobile handset; and
displaying the direction and distance of the beacon relative to the wireless mobile handset on a display of the wireless mobile handset.

11. The method of claim 10 further comprising pairing at least one beacon with the wireless mobile handset.

12. The method of claim 11 where pairing the at least one beacon with the wireless mobile handset comprises:
detecting the at least one beacon with the wireless mobile handset; and
entering a beacon passkey corresponding the at least one beacon via the wireless mobile handset.

13. The method of claim 10 where analyzing the location signals received from the selected beacon via an algorithm contained within a software application stored on a memory device within the wireless mobile handset comprises determining the signal strength and the probable relative direction between the beacon and wireless mobile handset.

14. The method of claim 13 where displaying the location of the beacon on the wireless mobile handset comprises representing the probable relative direction between the beacon and wireless mobile handset with an arrow pointing in the probable relative direction of the beacon irrespective of the handset orientation relative to magnetic north on a display of the wireless mobile handset.

15. The method of claim 10 where scanning for the location of the selected beacon through a short-range WPAN channel with a plurality of antennas disposed within the case comprises sweeping the wireless mobile handset and case through a field of observation.

16. The method of claim 10 where scanning for the location of the selected beacon through a wireless data network comprises:
requesting GPS coordinate data for the selected beacon via a wireless data network through the wireless mobile handset;
contacting the selected beacon through the wireless data network and acquiring its GPS coordinate data; and
displaying the acquired GPS coordinate data for the selected beacon on the wireless data network through the wireless mobile handset.

17. The method of claim 10 where selecting a beacon from a plurality of beacons displayed on the wireless mobile handset comprises selecting a wireless device that is paired to the wireless mobile handset.

18. The method of claim 10 further comprising prohibiting the wireless mobile handset from being paired with a beacon or other wireless device.

19. The method of claim 13 further comprising adjusting a level of transmit power to a higher level to extend the scanning range for the selected beacon or to a lower level to reduce interference according to the determined signal strength between the beacon and the wireless mobile handset.

20. The method of claim 10 further comprising downloading the software application to the memory device within the wireless mobile handset.
